(19) United States
(12) Patent Application Publication
(10) Pub. No.: US 2023/0316225 A1
(43) Pub. Date: Oct. 5, 2023

(54) MEDICAL CLAIM DENIAL PREDICTION USING AN ARTIFICIAL INTELLIGENCE PREDICTION ENGINE INCLUDING A HYBRID DECISION TREE

(71) Applicant: Change Healthcare Holdings LLC, Nashville, TN (US)

(72) Inventors: Max Zhao, Princeton, NJ (US); Shounak Datta, Seattle, WA (US); Ting-yu Ho, Seattle, WA (US); Vallabha Jagdish, San Jose, CA (US); Feili Yu, Shoreline, WA (US)

(21) Appl. No.: 17/656,931

(22) Filed: Mar. 29, 2022

(51) Int. Cl. G06Q 10/10; G06N 5/00

(52) U.S. Cl. CPC G06Q 10/10; G06N 5/003

(57) ABSTRACT

A method includes receiving a medical claim for payment by a payor; and using an artificial intelligence engine to predict whether the medical claim will be denied by the payor, the artificial intelligence engine comprising a decision tree having at least one level, such that each of the at least one level has a split function associated therewith corresponding to one of a plurality of features associated with the medical claim; wherein a node in the decision tree terminates when at least one of a plurality of termination criteria are satisfied.

### FIELD

The present inventive concepts relate generally to health care systems and services and, more particularly, to the use of artificial intelligence systems that can be used for event prediction, such as the denial of payment for a medical claim.

### BACKGROUND

Health care service providers have patients that pay for their care using a variety of different payors. For example, a medical facility or practice may serve patients that pay by way of different insurance companies including, but not limited to, private insurance plans, government insurance plans, such as Medicare, Medicaid, and state or federal public employee insurance plans, and/or hybrid insurance plans, such as those that are sold through the Affordable Care Act. When providers submit claims to the payors for payment, however, the claims can be denied in whole or in part for a variety of different reasons. Some of these denials may be overcome if a provider can understand the reason for the denial and can remedy any deficiency in the originally submitted claim. Unfortunately, many denied claims are never overcome resulting in lost revenue for providers and/or more out of pocket expense for patients. As a result, some claim denial prediction systems have been developed in which the categorical variables used in making the denial prediction are converted to numeric values using, for example, one hot encoding or a numerical conversion in which a categorical variable is assigned an average and a standard deviation. Using a traditional binary-split tree as a classification technique, however, may be difficult as several variables that may be used in predicting a claim denial may each have many distinct values, e.g., procedure code, diagnostic code, and the like. Using these variables as split functions or split criteria at various levels in the tree may result in an unmanageable depth of splits.

### SUMMARY

According to some embodiments of the inventive concept, a method comprises: receiving a medical claim for payment by a payor; and using an artificial intelligence engine to predict whether the medical claim will be denied by the payor, the artificial intelligence engine comprising a decision tree having at least one level, such that each of the at least one level has a split function associated therewith corresponding to one of a plurality of features associated with the medical claim; wherein a node in the decision tree terminates when at least one of a plurality of termination criteria are satisfied.

In other embodiments, the plurality of features includes a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business.

In still other embodiments, the plurality of termination criteria includes a historical number of medical claims having a classification corresponding to the node is less than a general node size threshold, the node has a claim denial probability associated therewith that exceeds a first denial threshold and the historical number of medical claims having the classification corresponding to the node is greater than a first node size threshold, the node has a claim denial probability associated therewith that is less than a second denial threshold and the historical number of medical claims having the classification corresponding to the node is greater than a second node size threshold, and the node is at a deepest level of the decision tree and has a claim denial probability associated therewith that is between the first denial threshold, and the second denial threshold.

In still other embodiments, the decision tree is associated with a claim denial reason used by the payor.

In still other embodiments, each of the at least one level has one or more denial rules corresponding thereto.

In still other embodiments, the claim denial reason is based on the one or more denial rules for each of the at least one level.

In still other embodiments, the artificial intelligence engine is trained using historical medical claims each of which has been approved or denied by the payor based on the claim denial reason.

According to some embodiments of the inventive concept, a system comprises a processor; and a memory coupled to the processor and comprising computer readable program code embodied in the memory that is executable by the processor to perform operations comprising: receiving a medical claim for payment by a payor; and using an artificial intelligence engine to predict whether the medical claim will be denied by the payor, the artificial intelligence engine comprising a decision tree having at least one level, such that each of the at least one level has a split function associated therewith corresponding to one of a plurality of features associated with the medical claim; wherein a node in the decision tree terminates when at least one of a plurality of termination criteria are satisfied.

In further embodiments, the plurality of features includes a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business.

In still further embodiments, the plurality of termination criteria includes a historical number of medical claims having a classification corresponding to the node is less than a general node size threshold, the node has a claim denial probability associated therewith that exceeds a first denial threshold and the historical number of medical claims having the classification corresponding to the node is greater than a first node size threshold, the node has a claim denial probability associated therewith that is less than a second denial threshold and the historical number of medical claims having the classification corresponding to the node is greater than a second node size threshold, and the node is at a deepest level of the decision tree and has a claim denial probability associated therewith that is between the first denial threshold, and the second denial threshold.

In still further embodiments, the decision tree is associated with a claim denial reason used by the payor.

In still further embodiments, each of the at least one level has one or more denial rules corresponding thereto.

In still further embodiments, the claim denial reason is based on the one or more denial rules for each of the at least one level.

In still further embodiments, the artificial intelligence engine is trained using historical medical claims each of which has been approved or denied by the payor based on the claim denial reason.

According to some embodiments of the inventive concept, a computer program product comprises a non-transitory computer readable storage medium comprising computer readable program code embodied in the medium that is executable by a processor to perform operations comprising: receiving a medical claim for payment by a payor; and using an artificial intelligence engine to predict whether the medical claim will be denied by the payor, the artificial intelligence engine comprising a decision tree having at least one level, such that each of the at least one level has a split function associated therewith corresponding to one of a plurality of features associated with the medical claim; wherein a node in the decision tree terminates when at least one of a plurality of termination criteria are satisfied.

In other embodiments, the plurality of features includes a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business.

In still other embodiments, the plurality of termination criteria includes a historical number of medical claims having a classification corresponding to the node is less than a general node size threshold, the node has a claim denial probability associated therewith that exceeds a first denial threshold and the historical number of medical claims having the classification corresponding to the node is greater than a first node size threshold, the node has a claim denial probability associated therewith that is less than a second denial threshold and the historical number of medical claims having the classification corresponding to the node is greater than a second node size threshold, and the node is at a deepest level of the decision tree and has a claim denial probability associated therewith that is between the first denial threshold, and the second denial threshold.

In still other embodiments, the decision tree is associated with a claim denial reason used by the payor; and each of the at least one level has one or more denial rules corresponding thereto.

In still other embodiments, the claim denial reason is based on the one or more denial rules for each of the at least one level.

In still other embodiments, the artificial intelligence engine is trained using historical medical claims each of which has been approved or denied by the payor based on the claim denial reason.

It is noted that aspects described with respect to one embodiment may be incorporated in different embodiments although not specifically described relative thereto. That is, all embodiments and/or features of any embodiments can be combined in any way and/or combination. Moreover, other methods, systems, articles of manufacture, and/or computer program products according to embodiments of the inventive concept will be or become apparent to one with skill in the art upon review of the following drawings and detailed description. It is intended that all such additional systems, methods, articles of manufacture, and/or computer program products be included within this description, be within the scope of the present inventive subject matter, and be protected by the accompanying claims.

### BRIEF DESCRIPTION OF THE DRAWINGS

Other features of embodiments will be more readily understood from the following detailed description of specific embodiments thereof when read in conjunction with the accompanying drawings, in which:

FIG. 1 is a block diagram that illustrates a communication network including an Artificial Intelligence (AI) assisted event prediction system in accordance with some embodiments of the inventive concept;

FIG. 2 is a block diagram of the AI assisted event prediction system of FIG. 1 in accordance with some embodiments of the inventive concept;

FIG. 3 is a flowchart that illustrates operations for predicting whether a payor will deny payment of a medical claim using the AI assisted event prediction system of FIG. 1 in accordance with some embodiments of the inventive concept;

FIG. 4 is a block diagram of a hybrid decision tree used in the AI assisted event prediction system of FIG. 1 in accordance with some embodiments of the inventive concept;

FIG. 5 is a block diagram that illustrates operations for deriving denial rules for denial reasons associated with a payor;

FIG. 6 is a data processing system that may be used to implement one or more servers in the AI assisted event prediction system of FIG. 1 in accordance with some embodiments of the inventive concept; and

FIG. 7 is a block diagram that illustrates a software/hardware architecture for use in the AI assisted event prediction system of FIG. 1 in accordance with some embodiments of the inventive concept.

### DETAILED DESCRIPTION

In the following detailed description, numerous specific details are set forth to provide a thorough understanding of embodiments of the present inventive concept. However, it will be understood by those skilled in the art that the present invention may be practiced without these specific details. In some instances, well-known methods, procedures, components, and circuits have not been described in detail so as not to obscure the present inventive concept. It is intended that all embodiments disclosed herein can be implemented separately or combined in any way and/or combination. Aspects described with respect to one embodiment may be incorporated in different embodiments although not specifically described relative thereto. That is, all embodiments and/or features of any embodiments can be combined in any way and/or combination.

Embodiments of the inventive concept are described herein in the context of a prediction engine that includes a machine learning engine and an artificial intelligence (AI) engine. It will be understood that embodiments of the inventive concept are not limited to a machine learning implementation of the prediction engine and other types of AI systems may be used including, but not limited to, a multi-layer neural network, a deep learning system, a natural language processing system, and/or computer vision system Moreover, it will be understood that the multi-layer neural network is a multi-layer artificial neural network comprising artificial neurons or nodes and does not include a biological neural network comprising real biological neurons. It will be understood that the multi-layer neural network is a multi-layer artificial neural network comprising artificial neurons or nodes and does not include a biological neural network comprising real biological neurons. The machine learning engine and AI engine described herein may be configured to transform a memory of a computer system to include one or more data structures, such as, but not limited to, arrays, extensible arrays, linked lists, binary decision trees, balanced decision trees, hybrid decision trees, heaps, stacks, and/or queues. These data structures can be configured or modified through the AI training process to improve the efficiency of a computer system when the computer system operates in an inference mode to make an inference, prediction, classification, or the like in response to input information or data provided thereto.

Some embodiments of the inventive concept stem from a realization that medical claim payment denials by payors, such as insurance companies, may result in lost revenue for providers and/or increased costs for patients that could be avoided if the denials were overcome or avoided. Embodiments of the inventive concept may provide a medical claim denial prediction system that may predict whether a medical claim will be denied in whole or in part by a payor. The medical claim denial system may use an AI engine that includes a decision tree having one or more levels. The split function associated with each level may correspond to one of a plurality of features associated with the medical claim. Termination criteria are defined that determine when a node in the decision tree terminates. Rather than using purity as the only termination criterion, additional criteria, such as, but not limited to, a historical number of medical claims having a classification corresponding to the node is less than a node size threshold, the node has a claim denial probability associated therewith that exceeds a first denial threshold, the node has a claim denial probability associated therewith that is less than a second denial threshold, and the node is at a deepest level of the decision tree and has a claim denial probability associated therewith that is between the first denial threshold, and the second denial threshold may also be used. This may reduce the number of nodes generated during a split to a more manageable number improving the efficiency of the prediction operation. The features used as a basis for the split functions at the various levels in the decision tree may include, but are not limited to, a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business. Denial rules applied on each level may be derived through the application of queries to historical claims processed by a payor to associate the rules with various denial reasons. Thus, the decision tree may be associated with a claim denial reason used by a payor with a different decision tree being generated for each unique combination of denial reason and payor.

Although described herein in the context of predicting events, such as the denial of payment of medical claims submitted by a medical service provider to one or more payors, the AI assisted event prediction system can be used in other contexts in accordance with other embodiments of the inventive concept including, but not limited to, agriculture, manufacturing, scientific research, retailing, and other endeavors. For example, with respect to agriculture, the AI assisted event prediction system may be used to predict yield based on factors, such as fertilizer, crop plant date, rain amounts, and sun amounts. With respect to manufacturing, the AI assisted event prediction system may be used to predict product output based on timing of arrival of various parts and components used in the manufacturing process and the historical downtime of machines used in manufacturing the product. With respect to retailing, the AI assisted event prediction system may be used to predict sales based on advertising, holidays, sale pricing, and other factors. With respect to scientific research, hypotheses may be generated as a prediction based on historical data associated with one or more phenomena.

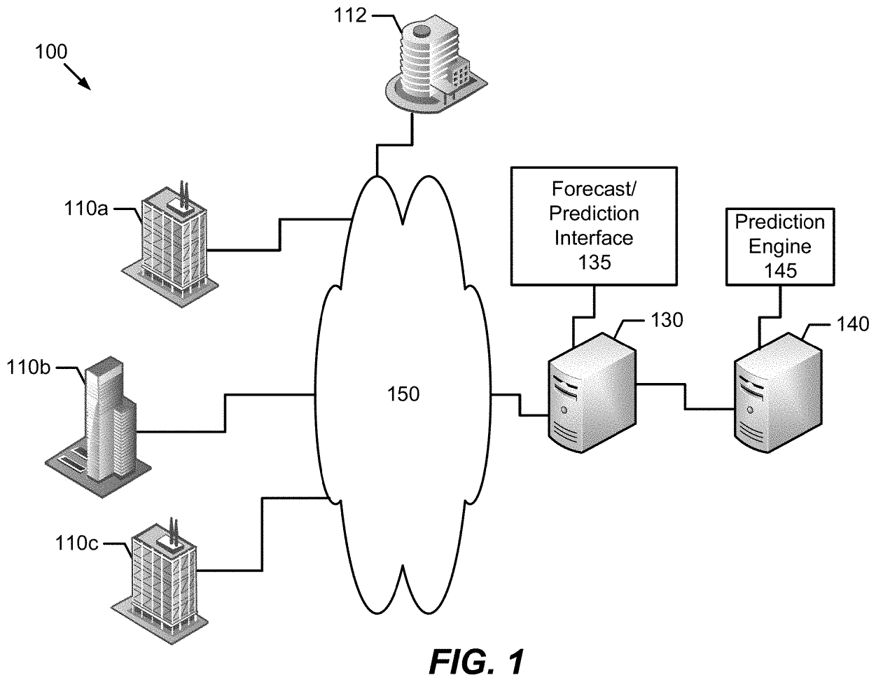

Referring to FIG. 1, a communication network 100 including an AI assisted event prediction system, in accordance with some embodiments of the inventive concept, comprises a plurality of health care provider facilities or practices 110a, 110b, and 110c that are coupled to an AI assisted event prediction system including a forecast/prediction server 130 and a prediction engine server 140. The health care provider facilities or practices 110a, 110b, and 110c may represent various types of organizations that are used to deliver health care services to patients, which are referred to generally herein as “providers.” The providers may include, but are not limited to, hospitals, medical practices, mobile patient care facilities, diagnostic centers, lab centers, and the like. The providers may operate by providing health care services for patients and then invoicing one or more payors for the services rendered. The payors may include, but are not limited to, private insurance plans, government insurance plans (e.g., Medicare, Medicaid, state, or federal public employee insurance plans), hybrid insurance plans (e.g., Affordable Care Act plans), private medical cost sharing plans, and the patients themselves.

According to some embodiments of the inventive concept, providers may access the AI assisted event prediction system to allow them to forecast or predict whether a medical claim submitted to a payor, such as payor 112, will be denied payment. The AI assisted event prediction system may include a forecast/prediction interface server 130, which includes a forecast/prediction interface module 135 to facilitate the transfer of medical claim and provider information between the respective providers 110a, 110b, and 110c, and a prediction engine server 140, which includes a prediction engine module 145. The prediction engine server 140 and prediction engine module 145 may be configured to receive medical claim information and provider information from the providers 110a, 110b, and 110c by way of the forecast/prediction interface server 130 and forecast/prediction interface module 135. The forecast/prediction interface module 135 in conjunction with the prediction engine module 145 may be further configured to generate a prediction whether a claim submitted to the payor will be denied payment in whole or in part.

It will be understood that the division of functionality described herein between the prediction engine server 140/prediction engine module 145 and the forecast/prediction interface server 130/forecast/prediction interface module 135 is an example. Various functionality and capabilities can be moved between the prediction engine server 140/prediction engine module 145 and the forecast/prediction interface server 130/forecast/prediction interface module 135 in accordance with different embodiments of the inventive concept. Moreover, in some embodiments, the prediction engine server 140/prediction engine module 145 and the forecast/prediction interface server 130/forecast/prediction interface module 135 may be merged as a single logical and/or physical entity.

A network 150 couples the providers 110a, 110b, and 110c to the forecast/prediction interface server 130/forecast/prediction interface module 135 and the payor 112. The network 150 may be a global network, such as the Internet or other publicly accessible network. Various elements of the network 150 may be interconnected by a wide area network, a local area network, an Intranet, and/or other private network, which may not be accessible by the general public. Thus, the communication network 150 may represent a combination of public and private networks or a virtual private network (VPN). The network 150 may be a wireless network, a wireline network, or may be a combination of both wireless and wireline networks.

The forecast/prediction service provided through the forecast/prediction interface server 130, forecast/prediction interface system module 135, prediction engine server 140, and prediction engine module 145, in some embodiments, may be embodied as a cloud service. For example, providers may integrate their claims generation systems with the AI assisted event prediction service and access the service as a Web service. In some embodiments, the AI assisted event prediction service may be implemented as a Representational State Transfer Web Service (RESTful Web service). The forecast/prediction interface system module 135 may further provide an interface for communicating the medical claim denial predictions generated by the prediction engine server 140/prediction engine module 145 to, for example, a health care practice or facility manager. The interface may be embodied in a variety of ways including, but not limited to, an Application Programming Interface (API), one or more tables, one or more graphs/charts, a screen with one or more panes of text and/or graphic information, or the like. The predictive information conveyed to a health care practice or facility manager may assist the manager in identifying claims that are likely to be denied allowing for the ability to make corrections before submission to a payor. In other applications, a payor may make use of the medical claim denial prediction service for use in auditing processed claims to confirm denials on denied claims or identify potential claims that have not been denied to determine if they have been approved for payment in error. A payor may also use the medical claim denial prediction service to as a first screening mechanism to identify claims that have a high probability for denial.

Although FIG. 1 illustrates an example communication network including an AI assisted event prediction system for predicting whether a payor will deny payment for a medical claim, it will be understood that embodiments of the inventive subject matter are not limited to such configurations, but are intended to encompass any configuration capable of carrying out the operations described herein.

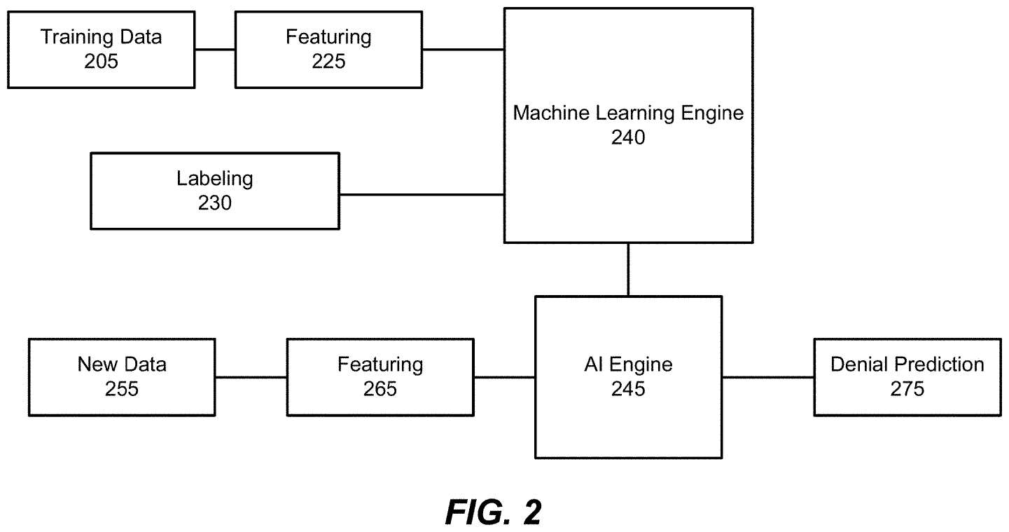

FIG. 2 is a block diagram of the prediction engine 145 used in the AI assisted event prediction system in accordance with some embodiments of the inventive concept. As shown in FIG. 2, the prediction engine 145 may include both training modules and modules used for processing new data on which to make event predictions. The modules used in the training portion of the prediction engine 145 include the training data 205, the featuring module 225, the labeling module 230, and the machine learning engine 240. The training data 205 my comprise information associated with a stimulus that may trigger an event. In some embodiments of the inventive concept, the training data may comprise information associated with medical claims for services provided to one or more patients, information associated with the one or more providers that provided the services to the one or more patients, and information associated with the payors of the medical claims. The featuring module 225 is configured to identify the individual independent variables that are used by the prediction engine 145 to make predictions, which may be considered a dependent variable. For example, the training data 205 may be generally unprocessed or formatted and include extra information in addition to medical claim information, provider information, and payor information. For example, the medical claim data may include account codes, business address information, and the like, which can be filtered out by the featuring module 225. The features extracted from the training data 205 may be called attributes and the number of features may be called the dimension. The labeling module 230 may be configured to assign defined labels to the training data and to the generated predictions to ensure a consistent naming convention for both the input features and the predicted outputs. The machine learning engine 240 may process both the featured training data 205, including the labels provided by the labeling module 230, and may be configured to test numerous functions to establish a quantitative relationship between the featured and labeled input data and the predicted outputs. The machine learning engine 240 may use modeling techniques to evaluate the effects of various input data features on the predicted outputs. These effects may then be used to tune and refine the quantitative relationship between the featured and labeled input data and the predicted outputs. The tuned and refined quantitative relationship between the featured and labeled input data generated by the machine learning engine 240 is output for use in the AI engine 245. The machine learning engine 240 may be referred to as a machine learning algorithm.

The modules used for processing new data on which to make event predictions include the new data 255, the featuring module 265, the AI engine module 245, and the event prediction module 275. The new data 255 may be the same data/information as the training data 205 in content and form except the data will be used for an actual event forecast or prediction, e.g., a prediction of whether a medical claim will be denied by a payor. Likewise, the featuring module 265 performs the same functionality on the new data 255 as the featuring module 225 performs on the training data 205. The AI engine 245 may, in effect, be generated by the machine learning engine 240 in the form of the quantitative relationship determined between the featured and labeled input data and the predicted outputs. The AI engine 245 may, in some embodiments, be referred to as an AI model. The AI engine 245 may be configured to output predicted events via the event prediction module 275. The event prediction module 275 may be configured to communicate the event prediction in a variety of formats and may include additional information, including, but not limited to, illustrations of the event in comparisons to an idealized version of the event, comparison of the event outcome relative to one or more of the featured inputs, and trends in the event outcomes including a breakdown of such trends relative to one or more of the featured inputs. In some embodiments, the predicted events are generated based on stimulus, such as medical claim information, provider information, and payor information. The predicted events may include, for example, whether a payor will deny payment on a medical claim.

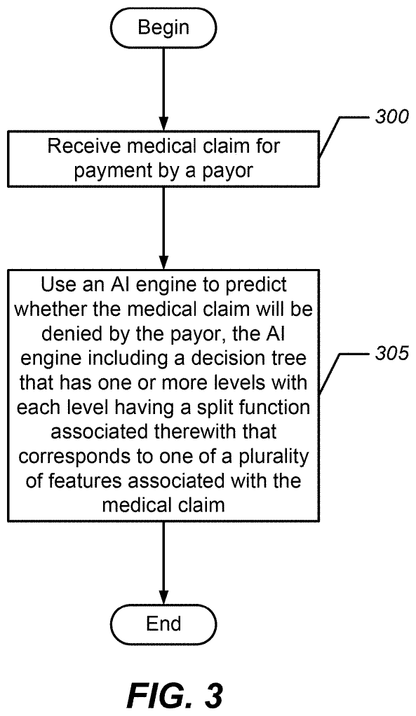

FIG. 3 is a flowchart that illustrates operations for predicting whether a payor will deny payment of a medical claim using the AI assisted event prediction system of FIG. 1 in accordance with some embodiments of the inventive concept. Operations begin at block 300 where a medical claim is received for payment by a payor. An AI prediction engine, e.g., prediction engine server 140/prediction engine module 145 is used to predict whether the medical claim will be denied by the payor at block 305. The AI engine includes a decision tree that has one or more levels. Each of the levels has a split function associated therewith that corresponds to one of a plurality of features associated with the medical claim. According to some embodiments of the inventive concept, the decision tree is a hybrid decision tree that includes multiple criteria for when a node terminates. In addition to using node purity, additional criteria, such as, but not limited to, a historical number of medical claims having a classification corresponding to the node is less than a general node size threshold, the node has a claim denial probability associated therewith that exceeds a first denial threshold, the node has a claim denial probability associated therewith that is less than a second denial threshold, and the node is at a deepest level of the decision tree and has a claim denial probability associated therewith that is between the first denial threshold, and the second denial threshold may also be used. In the context of predicting whether a claim will be denied payment by a payor, a hybrid decision tree trained for a particular denial reason of a particular payor may use a general node size threshold of 10, i.e., there are 10 or fewer claims during training of the hybrid tree that are represented by that node. In some embodiments, the first denial threshold may be about 85%, i.e., there is an 85% probability that a claim represented by this node will be denied payment by the payor for the reason associated with the hybrid decision tree, and the second denial threshold is about 10%, i.e., there is a 10% probability that a claim represented by this node will be denied payment by the payor for the reason associated with the hybrid decision tree. In some embodiments, the first denial threshold may have a first node size threshold associated therewith and the second denial threshold may have a second node size threshold associated therewith. That is, for a node to terminate by having a claim denial probability that exceeds the first denial probability, the node would also have to have a size that exceeds the first node size threshold. Similarly, for a node to terminate by having a claim denial probability that is less than the second denial threshold, the node would also have to have a size that exceeds the second node size threshold. The first and second node size thresholds may be defined to be greater than the general node size threshold.

According to some embodiments of the inventive concept, a variety of different features may be used as a basis for the split functions at the various levels of the hybrid decision tree. These features may include, but are not limited to, a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business.

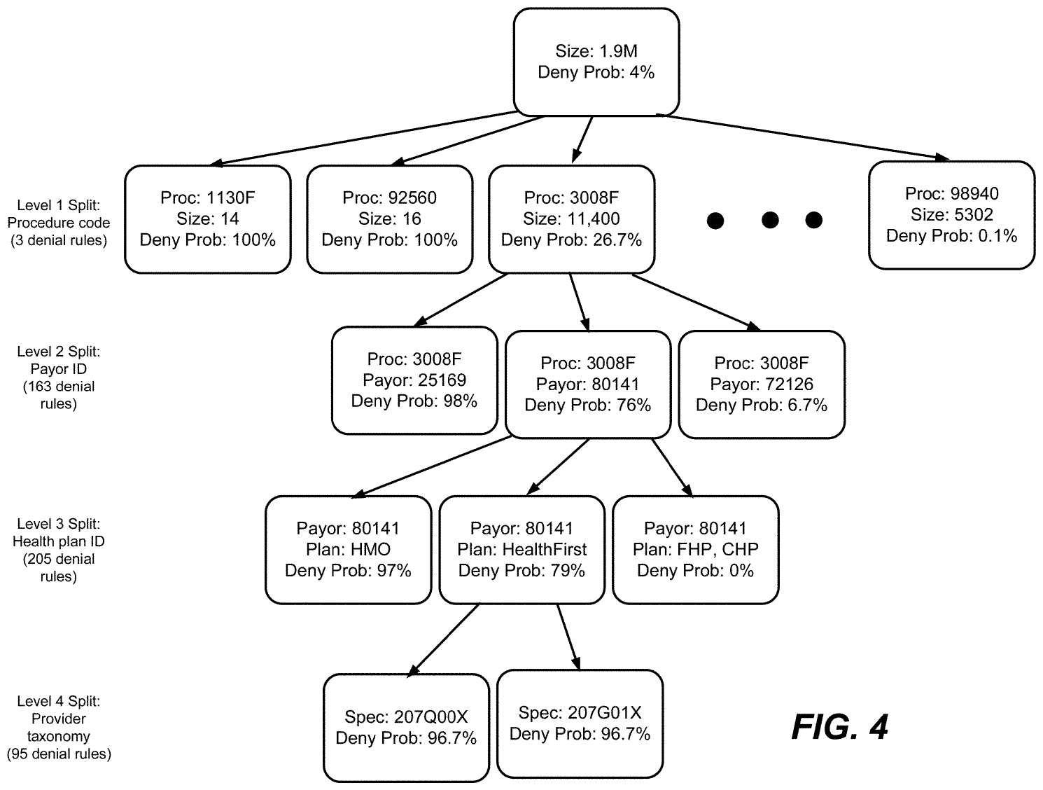

FIG. 4 is a block diagram of a hybrid decision tree used in the AI assisted event prediction system of FIG. 1 in accordance with some embodiments of the inventive concept. The hybrid decision tree shown in FIG. 4 may be used in the machine learning engine 240 and AI engine 245 of FIG. 2. In the example shown, the hybrid decision tree is trained using 1.9 million claims processed by a payor, which has a 4% denial probability for a particular denial reason. The hybrid decision tree is four levels deep in which the features procedure code, payor identification, health plan identification, and provider taxonomy are the four features used as a basis for the four split functions. In the example shown, the node termination criteria include a general minimum node size of 10, a denial probability greater than 85% with a first node size threshold of 12, and a denial probability of less than 10% with a second node size threshold of 12. At the first level, two nodes terminate because of denial probabilities that exceed 85% with node sizes greater than 12 and one node terminates because of a non-denial probability of less than 10% with a node size greater than 12. One node has a denial probability of 26.7% and is further split based on payor identification in level two. At this level, one node terminates with a denial probability that exceeds 85% (98%) and a node size greater than 12 and one node terminates with a denial probability of 6.7% and a node size greater than 12. A third node with a denial probability of 76% is further split based on health plan identification. At this third level, one node terminates with a denial probability of 97% and a node size greater than 12 and another node terminates with a denial probability of 0% and a node size greater than 12. A third node with a denial probability of 79% is further split at level four based on provider taxonomy. Both nodes at level four terminate with denial probabilities of 96.7%. Note that a node may also terminate if it has a denial probability between 10% and 85% if the node is at the last level of the hybrid decision tree and there are no more features remaining to use as basis for splitting the node. Various rules may be derived that correspond to each level in the hybrid tree and are used to determine the medical claim denial percentages for this payor for this denial reason. The hybrid tree of FIG. 4 may be duplicated for each denial reason of a payor. The denial rules may be generated through a discovery process by evaluating claims that have been processed by a payor.

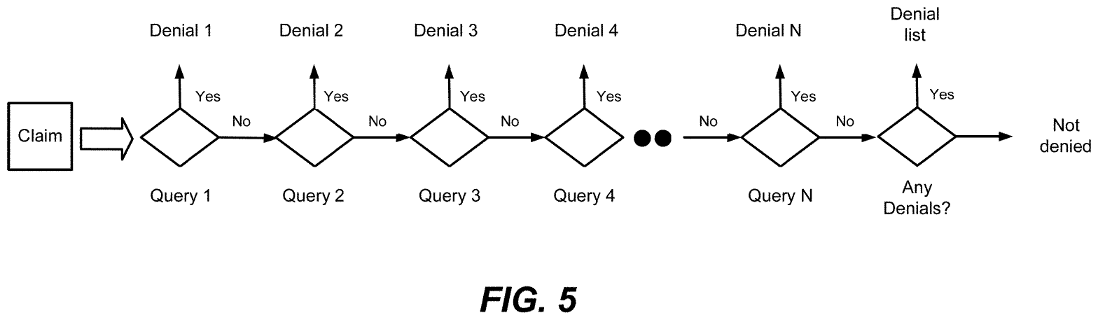

FIG. 5 is a block diagram that illustrates operations for deriving denial rules for denial reasons associated with a payor. As shown in FIG. 5, various claims that have been processed by a payor may be evaluated by applying various queries thereto (Query 1 through Quern N). These queries may correspond to various denial reasons used by the payor. For example, Query 1 may be “Is the service covered by the patient's health plan?” Query 1 may be associated with denial reason “Denial 1.” When claims are found that are denied payment based on denial reason “Denial 1,” the individual claims are examined to determine the various combination of features that are present in the claims that led to the claims being denied using this denial reason. One or more rules may then be derived or generated based on the presence or absence of various features in combination. This process is performed for all the denial reasons used by the payor for the sample claims that have been obtained to generate a denial list. A hybrid decision tree as shown in FIG. 4 may then be generated for each of the denial reasons in the denial list used by that payor with the rules derived for the respective denial reasons associated with the respective levels of the hybrid tree.

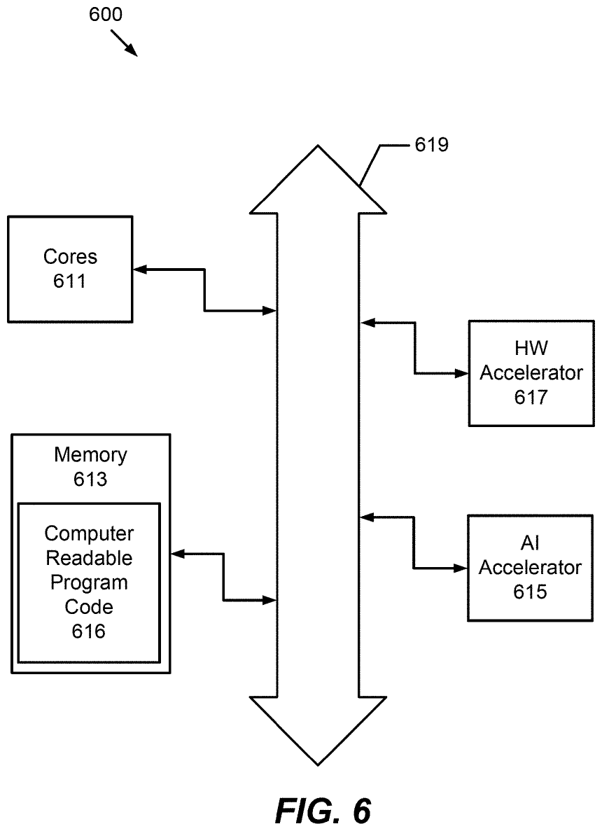

FIG. 6 is a data processing system that may be used to implement one or more servers in the AI assisted event prediction system of FIG. 1 in accordance with some embodiments of the inventive concept. As shown in FIG. 6, the data processing system 600 may include at least one core 611, a memory 613, an Artificial Intelligence (AI) accelerator 615, and a hardware (HW) accelerator 617. The at least one core 611, the memory 613, the AI accelerator 615, and the HW accelerator 617 may communicate with each other through a bus 1519.

The at least one core 611 may be configured to execute computer program instructions. For example, the at least one core 611 may execute an operating system and/or applications represented by the computer readable program code 616 stored in the memory 613. In some embodiments, the at least one core 611 may be configured to instruct the AI accelerator 615 and/or the HW accelerator 617 to perform operations by executing the instructions and obtain results of the operations from the AI accelerator 615 and/or the HW accelerator 617. In some embodiments, the at least one core 611 may be an ASIP customized for specific purposes and support a dedicated instruction set.

The memory 613 may have an arbitrary structure configured to store data. For example, the memory 613 may include a volatile memory device, such as dynamic random-access memory (DRAM) and static RAM (SRAM), or include a non-volatile memory device, such as flash memory and resistive RAM (RRAM). The at least one core 611, the AI accelerator 615, and the HW accelerator 617 may store data in the memory 613 or read data from the memory 613 through the bus 619.

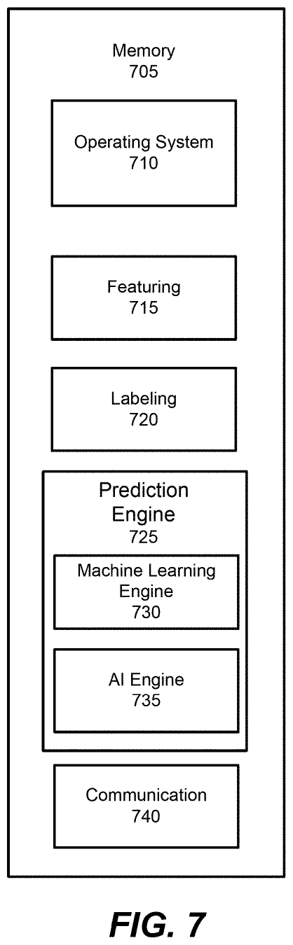

FIG. 7 illustrates a memory 705 that may be used in embodiments of data processing systems, such as the prediction engine server 140 of FIG. 1 and the data processing system 600 of FIG. 11, respectively, to facilitate AI assisted event prediction according to some embodiments of the inventive concept. The memory 705 is representative of the one or more memory devices containing the software and data used for facilitating operations of the prediction engine server 140 and prediction engine 145 as described herein. The memory 705 may include, but is not limited to, the following types of devices: cache, ROM, PROM, EPROM, EEPROM, flash, SRAM, and DRAM. As shown in FIG. 12, the memory 705 may contain five or more categories of software and/or data: an operating system 710, a featuring module 715, a labeling module 720, a prediction engine module 725, and a communication module 740. In particular, the operating system 710 may manage the data processing system's software and/or hardware resources and may coordinate execution of programs by the processor. The featuring module 715 may be configured to perform one or more of the operations described above with respect to the featuring modules 225, 265, the flowchart of FIG. 3, and the block diagrams of FIGS. 4 and 5. The labeling module 720 may be configured to perform one or more of the operations described above with respect to the labeling module 230, the flowchart of FIG. 3, and the block diagrams of FIGS. 4 and 5. The prediction engine 725 may comprise a machine learning engine module 730 and an AI engine module 735. The machine learning engine module 730 may be configured to perform one or more operations described above with respect to the machine learning engine 240, the flowchart of FIG. 3, and the block diagrams of FIGS. 4 and 5. The AI engine module 735 may be configured to perform one or more operations described above with respect to the AI engine 245, the flowchart of FIG. 3, and the block diagrams of FIGS. 4 and 5. The communication module 740 may be configured to support communication between, for example, the prediction engine server 140 and the forecast/prediction interface server 130, the payor 112, and/or providers 110a, 110b, and 110c.

Although FIGS. 6 and 7 illustrate hardware/software architectures that may be used in data processing systems, such as the prediction engine server 140 of FIG. 1 and the data processing system 600 of FIG. 6, respectively, in accordance with some embodiments of the inventive concept, it will be understood that embodiments of the present invention are not limited to such a configuration but is intended to encompass any configuration capable of carrying out operations described herein.

Computer program code for carrying out operations of data processing systems discussed above with respect to FIGS. 1-7 may be written in a high-level programming language, such as Python, Java, C, and/or C++, for development convenience. In addition, computer program code for carrying out operations of the present invention may also be written in other programming languages, such as, but not limited to, interpreted languages. Some modules or routines may be written in assembly language or even micro-code to enhance performance and/or memory usage. It will be further appreciated that the functionality of any or all the program modules may also be implemented using discrete hardware components, one or more application specific integrated circuits (ASICs), or a programmed digital signal processor or microcontroller.

Moreover, the functionality of the prediction engine server 140 of FIG. 1 and the data processing system 600 of FIG. 6 may each be implemented as a single processor system, a multi-processor system, a multi-core processor system, or even a network of stand-alone computer systems, in accordance with various embodiments of the inventive concept. Each of these processor/computer systems may be referred to as a “processor” or “data processing system.”

The data processing apparatus described herein with respect to FIGS. 1-7 may be used to facilitate AI assisted event prediction according to some embodiments of the inventive concept described herein. These apparatus may be embodied as one or more enterprise, application, personal, pervasive and/or embedded computer systems and/or apparatus that are operable to receive, transmit, process and store data using any suitable combination of software, firmware and/or hardware and that may be standalone or interconnected by any public and/or private, real and/or virtual, wired and/or wireless network including all or a portion of the global communication network known as the Internet, and may include various types of tangible, non-transitory computer readable media. In particular, the memory 705 when coupled to a processor includes computer readable program code that, when executed by the processor, causes the processor to perform operations including one or more of the operations described herein with respect to FIGS. 1-5.

Some embodiments of the inventive concept described herein may provide an AI assisted event prediction system that may forecast or predict when an event will occur in response to a stimulus. The event prediction system may be used in many different contexts and technological areas including the delivery of healthcare services, management of healthcare facilities and practices, and processing of medical claims received at a payor from one or more providers. The event prediction system may be trained using historical records, i.e., medical claims, generated for invoicing payors for the delivery of health care services and products by providers. The AI assisted event prediction system may allow a health care facility or practice to improve the management of their organization and delivery of health care services and products through improved forecasting of medical claims being denied payment by a payor. In addition, payors may use the claim payment denial prediction system to audit their processed claims to confirm whether claims were properly denied payment or identify potential claims that should have been denied payment, but were paid instead. Payors may also use the claim payment denial prediction system to filter medical claims to identify those that likely should be denied thereby improving the efficiency of processing medical claims received from providers.

### Further Definitions and Embodiments

In the above description of various embodiments of the present inventive concept, it is to be understood that the terminology used herein is for the purpose of describing embodiments only and is not intended to be limiting of the invention. Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of this specification and the relevant art and will not be interpreted in an idealized or overly formal sense expressly so defined herein.

The flowchart and block diagrams in the figures illustrate the architecture, functionality, and operation of possible implementations of systems, methods, and computer program products according to various aspects of the present inventive concept. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing aspects only and is not intended to be limiting of the inventive concept. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Like reference numbers signify like elements throughout the description of the figures.

In the above-description of various embodiments of the present inventive concept, aspects of the present inventive concept may be illustrated and described herein in any of a number of patentable classes or contexts including any new and useful process, machine, manufacture, or composition of matter, or any new and useful improvement thereof. Accordingly, aspects of the present inventive concept may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present inventive concept may take the form of a computer program product comprising one or more computer readable media having computer readable program code embodied thereon.

Any combination of one or more computer readable media may be used. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

The description of the present inventive concept has been presented for purposes of illustration and description, but is not intended to be exhaustive or limited to the inventive concept in the form disclosed. Many modifications and variations will be apparent to those of ordinary skill in the art without departing from the scope and spirit of the inventive concept. The aspects of the inventive concept herein were chosen and described to best explain the principles of the inventive concept and the practical application, and to enable others of ordinary skill in the art to understand the inventive concept with various modifications as are suited to the particular use contemplated.

What is claimed is:

1. A method, comprising:
receiving a medical claim for payment by a payor; and
using an artificial intelligence engine to predict whether the medical claim will be denied by the payor, the artificial intelligence engine comprising a decision tree having at least one level, such that each of the at least one level has a split function associated therewith corresponding to one of a plurality of features associated with the medical claim;
wherein a node in the decision tree terminates when at least one of a plurality of termination criteria are satisfied.

2. The method of claim 1, wherein the plurality of features includes a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business.

3. The method of claim 1, wherein the plurality of termination criteria includes a historical number of medical claims having a classification corresponding to the node is less than a general node size threshold, the node has a claim denial probability associated therewith that exceeds a first denial threshold and the historical number of medical claims having the classification corresponding to the node is greater than a first node size threshold, the node has a claim denial probability associated therewith that is less than a second denial threshold and the historical number of medical claims having the classification corresponding to the node is greater than a second node size threshold, and the node is at a deepest level of the decision tree and has a claim denial probability associated therewith that is between the first denial threshold, and the second denial threshold.

4. The method of claim 1, wherein the decision tree is associated with a claim denial reason used by the payor.

5. The method of claim 4, wherein each of the at least one level has one or more denial rules corresponding thereto.

6. The method of claim 5, wherein the claim denial reason is based on the one or more denial rules for each of the at least one level.

7. The method of claim 4, wherein the artificial intelligence engine is trained using historical medical claims each of which has been approved or denied by the payor based on the claim denial reason.

8. A system, comprising:
a processor; and
a memory coupled to the processor and comprising computer readable program code embodied in the memory that is executable by the processor to perform operations comprising:
receiving a medical claim for payment by a payor; and
using an artificial intelligence engine to predict whether the medical claim will be denied by the payor, the artificial intelligence engine comprising a decision tree having at least one level, such that each of the at least one level has a split function associated therewith corresponding to one of a plurality of features associated with the medical claim;
wherein a node in the decision tree terminates when at least one of a plurality of termination criteria are satisfied.

9. The system of claim 8, wherein the plurality of features includes a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business.

10. The system of claim 8, wherein the plurality of termination criteria includes a historical number of medical claims having a classification corresponding to the node is less than a general node size threshold, the node has a claim denial probability associated therewith that exceeds a first denial threshold and the historical number of medical claims having the classification corresponding to the node is greater than a first node size threshold, the node has a claim denial probability associated therewith that is less than a second denial threshold and the historical number of medical claims having the classification corresponding to the node is greater than a second node size threshold, and the node is at a deepest level of the decision tree and has a claim denial probability associated therewith that is between the first denial threshold, and the second denial threshold.

11. The system of claim 8, wherein the decision tree is associated with a claim denial reason used by the payor.

12. The system of claim 11, wherein each of the at least one level has one or more denial rules corresponding thereto.

13. The system of claim 12, wherein the claim denial reason is based on the one or more denial rules for each of the at least one level.

14. The system of claim 11, wherein the artificial intelligence engine is trained using historical medical claims each of which has been approved or denied by the payor based on the claim denial reason.

15. A computer program product, comprising:
a non-transitory computer readable storage medium comprising computer readable program code embodied in the medium that is executable by a processor to perform operations comprising:
receiving a medical claim for payment by a payor; and
using an artificial intelligence engine to predict whether the medical claim will be denied by the payor, the artificial intelligence engine comprising a decision tree having at least one level, such that each of the at least one level has a split function associated therewith corresponding to one of a plurality of features associated with the medical claim;
wherein a node in the decision tree terminates when at least one of a plurality of termination criteria are satisfied.

16. The computer program product of claim 15, wherein the plurality of features includes a procedure code, a payor identification, a health plan identification, a patient state, a diagnostic code, a procedure modifier, a provider taxonomy, billing provider national provider identifier (NPI), rendering provider NPI, place of services, claim filing indicator identification, claim service charge amount, patient age, patient gender, prior authorization index, or line of business.

17. The computer program product of claim 15, wherein the plurality of termination criteria includes a historical number of medical claims having a classification corresponding to the node is less than a general node size threshold, the node has a claim denial probability associated therewith that exceeds a first denial threshold and the historical number of medical claims having the classification corresponding to the node is greater than a first node size threshold, the node has a claim denial probability associated therewith that is less than a second denial threshold and the historical number of medical claims having the classification corresponding to the node is greater than a second node size threshold, and the node is at a deepest level of the decision tree and has a claim denial probability associated therewith that is between the first denial threshold, and the second denial threshold.

18. The computer program product of claim 15, wherein the decision tree is associated with a claim denial reason used by the payor; and wherein each of the at least one level has one or more denial rules corresponding thereto.

19. The computer program product of claim 18, wherein the claim denial reason is based on the one or more denial rules for each of the at least one level.

20. The computer program product of claim 18, wherein the artificial intelligence engine is trained using historical medical claims each of which has been approved or denied by the payor based on the claim denial reason.
